(19) United States
(12) Patent Application Publication
(10) Pub. No.: US 2014/0328258 A1
(43) Pub. Date: Nov. 6, 2014

(54) DYNAMIC RESOURCE ALLOCATION METHOD

(71) Applicant: National Taiwan University of Science and Technology, Taipei (TW)

(72) Inventors: Ray-Guang Cheng, Keelung City (TW); Firas Mardan Shnain Altaee, New Taipei City (TW); Chia-Hung Wei, Taipei City (TW)

(21) Appl. No.: 13/905,083

(22) Filed: May 29, 2013

(30) Foreign Application Priority Data
May 3, 2013 (TW) 102115932

(51) Int. Cl. H04W 72/04; H04W 4/00

(52) U.S. Cl. CPC H04W 72/0446; H04W 4/005
USPC 370/329

(57) ABSTRACT

A dynamic resource allocation method is introduced herein. The method is adapted to a base station. The method includes the following steps. A number of contending devices in the random access slot is estimated. A reference value is calculated according to the number of the contending devices and a resource allocation parameter. A number of specific resources is calculated according to the number of the contending devices, a number of acknowledgeable machine-type communication devices of the base station at the random access slot and a preamble detection probability. A number of reserved random access opportunities is determined according to a maximum number of the random access opportunities, the number of the specific resources and the reference value. The resources are allocated to the at least one machine-type communication device according to the number of the reserved random access opportunities.

### CROSS-REFERENCE TO RELATED APPLICATION

This application claims the priority benefit of Taiwan application serial no. 102115932, filed on May 3, 2013. The entirety of the above-mentioned patent application is hereby incorporated by reference herein and made a part of this specification.

### BACKGROUND

1. Field of the Invention

The invention relates to a resource allocation method, in particular, to a dynamic resource allocation method.

2. Description of Related Art

During the past decade, considerable research efforts have investigated the emergent topic of Internet of Things (IoT), where heterogeneous devices, spanning from smartphones and wireless sensors up to network-enabled physical objects can seamlessly interoperate in globally integrated communications platforms. IoT opens opportunities for much needed applications, some of which have already been implemented and others being under research.

Machine-type communications (MTC) is the most solid enabler to the prospective IoT and in many contexts the two concepts are used interchangeably. Abundant researches for standardizing MTC have been published through several global organizations. Recently, Third Generation Partnership Project (3GPP), the Alliance for Telecommunications Industry Solutions (ATIS), the China Communications Standards Association (CCSA), the Open Mobile Alliance (OMA), IEEE and the European Telecommunications Standards Institute (ETSI) have launched standardization activities on MTC. 3GPP and IEEE address cellular MTC, particularly how wireless cellular networks can support MTC. ETSI, in contrast, addresses the MTC service architecture, its components, and the interactions between its three domains, i.e. application, network and devices domains.

Regardless of whether cellular MTC is implemented over existing networks standards or over the upcoming LTE-A, it faces a severe Radio Access Network (RAN) overload problem. A large number of devices are expected to be deployed in small areas. Although MTC traffic is characterized with small data, the highly dense distribution of devices supported by one cell generates an enormous transmission load. Congestion in the signaling network is caused by the large number of MTC devices trying almost simultaneously to access the network. In a 3GPP system supporting MTC applications, this kind of overload situation of the network can be caused by a large number of metering devices becoming active almost simultaneously after a period of power outage.

3GPP has proposed several means to the network operator and MTC user to spread peaks of signaling traffic. The solutions are grouped into two categories: push-based and Pull-based. As the name implies, Push-based schemes implies that devices push their traffic into the network with no restrictions until RAN overload is detected. On the other hand, pull-based RAN overload control schemes suggest that traffic is pulled by the network through paging and group paging which prevents RAN overload from happening in the first place.

Pull-based schemes enable the network operator and the MTC user to have means to enforce a maximum rate for the transmissions by MTC devices. In addition, since the network is aware of the number of paged devices, the behavior of their access attempts can be estimated more accurately. Thus, pull-based schemes, embodied by paging and group paging, are very feasible solutions for RAN overload in a wide range of MTC applications.

Group paging differs from paging in that a paging message carries an ID corresponding to a group of devices rather than one single device. As far as MTC applications are concerned, group paging is more practical than paging. In MTC systems, it is possible that the network needs to notify a large number of devices at the same time or during a small time period. If the MTC devices are notified using a one-by-one paging approach, the process would produce lots of signaling overhead, consume massive system resources and induce intolerable delay. Instead, one paging message can be used to notify a bulk of devices instantly. Devices within the same group share one ID(i.e., a group ID (GID)). After joining the communication group, MTC devices monitor the Paging Radio Network Temporary Identifier (P-RNTI) in Physical Downlink Control Channel (PDCCH) at paging occasions. After recognizing the matched GID, MTC devices start performing the random access procedure. From the viewpoint of the network, after the eNB sending the paging message, the eNB reserves a number of resources at each Random Access Channel (RACH) occurrence, which is used by the paged group to perform random access. The period of time starting from paging a group until the complete release of resources allocated for that group is referred to as a paging cycle.

Based on performance metrics defined by 3GPP, the performance of group paging for MTC is investigated in many existing literatures. Group paging standards suggest that a fixed number of resources are allocated in each RACH during the paging cycle. However, MTC devices seize their retransmission attempts upon success or the depletion of the allowable number of retransmission, so the number of contending devices changes from one RACH to another. Accordingly, resources may be underutilized in the random access slots where the number of contending devices is very low.

### SUMMARY

Accordingly, the present invention is directed to a dynamic resource allocation method, which could properly determine the allocated resources according to the number of contending devices.

A dynamic resource allocation method is introduced herein. The method is adapted to a base station for allocating resources to at least one machine-type communication device within a communication group at a random access slot. The method includes the following steps. A number of contending devices in the random access slot is estimated. A reference value is calculated according to the number of the contending devices and a resource allocation parameter. A number of specific resources is calculated according to the number of the contending devices, a number of acknowledgeable machine-type communication devices of the base station at the random access slot and a preamble detection probability. The specific resources are the resources required to detect the number of machine-type communication devices that is less than or equal to a number of acknowledgeable machine-type communication devices of the base station at the random access slot. A number of reserved random access opportunities is determined according to a maximum number of the random access opportunities, the number of the specific resources and the reference value. The resources are allocated to the at least one machine-type communication device according to the number of the reserved random access opportunities.

In an embodiment of the present invention, the step of estimating the number of the contending devices in the random access slot includes calculating the number of the contending devices in the random access slot by

$${M}_{i} = {\sum }_{n = 1}^{{N}_{PTmax}} {M}_{i} [ n ] ,$$

wherein Mᵢ is the number of the contending devices, N_{PTmax} is a number of retransmission limitation of the at least one machine-type communication device and Mᵢ[n] is a number of the at least one machine-type communication device transmitting an n-th preamble at the random access slot.

In an embodiment of the present invention, the step of calculating the reference value includes obtaining the resource allocation parameter by performing an optimization operation to an access success probability of the communication group to which the at least one machine-type communication device belongs; calculating a multiplication value by multiplying the resource allocation parameter and the number of the contending devices; obtaining the reference value by taking a ceiling function to the multiplication value.

In an embodiment of the present invention, the access success probability is defined as

$${P}_{S} = \frac{{\sum }_{i = 1}^{{I}_{max}} {\sum }_{n = 1}^{{N}_{PTmax}} {M}_{i , S} [ n ]}{M} ,$$

wherein P_{S} is the access success probability, Iₘₐₓ is a total number of random access slots in a paging cycle, N_{PTmax} is a number of retransmission limitation of the at least one machine-type communication device, M is a total number of the at least one machine-type communication device comprised in the communication group and M_{i,S}[n] is a number of the at least one machine-type communication device successfully complete a random access procedure at the random access slot after transmitting an n-th preamble.

In an embodiment of the present invention, the number of the specific resources is calculated by

$$⌈ - \frac{{\sum }_{n = 1}^{{N}_{PTmax}} {M}_{i} [ n ] {p}_{n}}{ln ( \frac{{N}_{UL}}{{M}_{i}} )} ⌉$$

wherein N_{PTmax} is a number of retransmission limitation of the at least one machine-type communication device, Mᵢ[n] is a number of the at least one machine-type communication device transmitting an n-th preamble at the random access slot, pₙ is the preamble detection probability of the n-th preamble, N_{UL} is the number of acknowledgeable machine-type communication devices of the base station at the random access slot, and ┌┐ is a ceiling function operator.

In an embodiment of the present invention, the step of determining the number of the reserved random access opportunities according to the maximum number of the random access opportunities, the number of the specific resources and the reference value includes taking a minimum value among the maximum number of the random access opportunities, the number of the specific resources and the reference value to be the number of the reserved random access opportunities.

A dynamic resource allocation method is introduced herein. The method is adapted to a base station for allocating resources to at least one machine-type communication device within a communication group. The method comprising the following steps. A resource allocation parameter is obtained by performing an optimization operation to an access success probability of the communication group to which the at least one machine-type communication device belongs. A paging message is sent to the at least one machine-type communication device within the communication group, wherein the paging message at least comprises the resource allocation parameter, a number of acknowledgeable machine-type communication devices of the base station, a maximum number of random access opportunities in an random access slot and a total number of the at least one machine-type communication device comprised in the communication group.

Based on the above description, the embodiments of the present invention provide a dynamic resource allocation method, which may significantly improve the resource allocation efficiency of the base station.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating an MTC system according to an exemplary embodiment of the present invention.

FIG. 2 is a flow chart illustrating the dynamic resource allocation method according to an exemplary embodiment of the present invention.

### DETAILED DESCRIPTION OF DISCLOSED EMBODIMENTS

Some embodiments of the present application will now be described more fully hereinafter with reference to the accompanying drawings, in which some, but not all embodiments of the application are shown. Indeed, various embodiments of the application may be embodied in many different forms and should not be construed as limited to the embodiments set forth herein; rather, these embodiments are provided so that this disclosure will satisfy applicable legal requirements. Like reference numerals refer to like elements throughout.

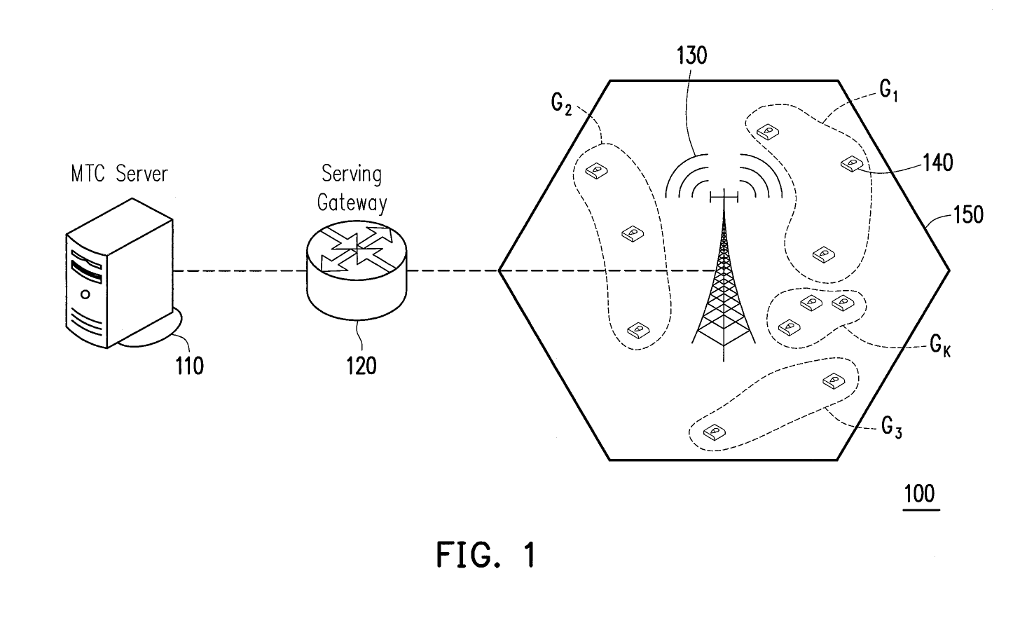

FIG. 1 is a schematic diagram illustrating an MTC system according to an exemplary embodiment of the present invention. In the present embodiment, the MTC system 100 includes an MTC server 110, a serving gateway 120, a base station 130 (i.e., an eNodeB) and a plurality of MTC devices 140. The MTC devices 140 may belong to a cell 150 managed by the base station 130. The MTC devices 140 may be partitioned into a plurality of communication groups G₁-G_{K} (K is a positive integer).

Each of the MTC devices 140 within the same group is assumed to share the same group ID (i.e., GID). For example, the MTC devices 140 within the communication group G₁ may share the same group ID, such as GID1. With the designated group ID, the MTC devices 140 within the communication group G₁ may monitor whether a paging message from the base station 130 contains information of GID1. If yes, the MTC devices 140 within the communication group G₁ would perform a random access procedure (e.g., transmit access attempts) at the upcoming random access slot of the

RACH. The random access slot is a special subframe reserved by the base station 130 for the MTC devices 140 to transmit access attempts.

The maximum number of the random access opportunities (RAO) of each of the random access slot is defined in the communication standard adopted by the MTC system 100. For example, if the MTC system 100 adopts LTE as a communication standard, the maximum number of the random access opportunities may be 54, which may be a product of the number of available frequencies, time slots and spreading codes (i.e., the code division multiple access (CDMA) codes). However, the maximum number of the random access opportunities could be set as any other possible numbers according to the design requirement of the system designers, which is not limited thereto.

In the present embodiment, it is assumed that the base station 130 reserves Rᵢ random access opportunities at the i-th random access slot (1≦Rᵢ≦N,1≦i—Iₘₐₓ), where N is the maximum number of random access opportunities in an random access slot (e.g., 54) and Iₘₐₓ is the total number of random access slots in a paging cycle. In other words, Rᵢ is the number of the reserved random access opportunities of the i-th random access slot. Each of the MTC devices 140 within the communication group G₁ randomly chooses a random access opportunity to transmit its access attempt. If more than two of the MTC devices 140 within the communication group G₁ choose the same random access opportunity to perform the access attempts, these MTC devices are defined to be collided with others. Each of the non-collided MTC devices 140 would be detected by the base station 130 according to a time-varying detection probability, which is related to the power ramping effect. In each of the random access slots, it is assumed that the base station 130 may acknowledge up to N_{UL} non-collided MTC devices 140 within the communication group G₁. In other words, N_{UL} is a number of acknowledgeable MTC devices 140 of the base station 130 at a random access slot.

When an MTC device does not receive an acknowledgement from the base station 130 within (T_{RAR}+W_{RAR}) subframes, the MTC device would assume its random access attempt has failed, where T_{RAR} is the processing time required by the base station 130 to detect the transmitted random access requests and W_{RAR} is the length of the random access response window. Each of the MTC devices whose random access attempt has failed performs a random backoff procedure according to a backoff window of size W_{BO} (which may be defined in the adopted communication standard). Next, the failed MTC devices may ramp up the transmit power and perform another access attempt until the times of retransmission reaches N_{PTmax}. N_{PTmax} is a number of retransmission limitation of the machine-type communication device 140, which may be defined in the adopted communication standard. For example, in LTE standard, N_{PTmax} is 10, which represents that the MTC device may perform 10 times of retransmission during the paging cycle as constantly experiencing failed random access attempt. Iₘₐₓ may be given as

$${I}_{max} = 1 + ( {N}_{PT max} - 1 ) \times ⌈ \frac{{T}_{RAR} + {W}_{RAR} + {W}_{BO}}{{T}_{RA\_REP}} ⌉ , \qquad ( 1 )$$

where T_{RA}_{_{—}}_{REP} is the interval between two neighbouring random access slots.

By the proposed method the present invention, an optimal value of the reserved random access opportunities (i.e., R₁) in a random access slot could be found, and hence the efficiency of resource allocation could be significantly improved. Detailed discussion would be provided in the following sections.

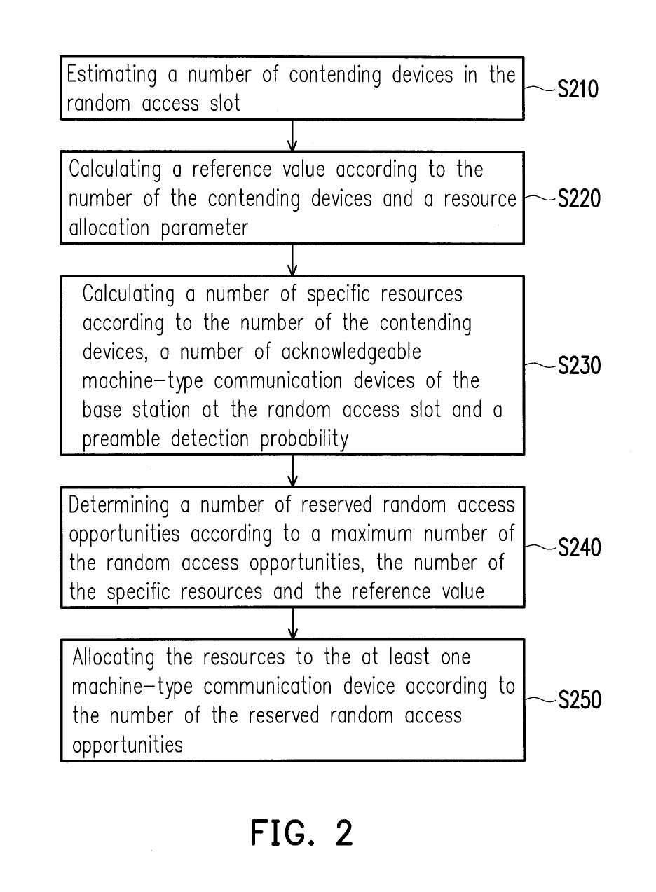

FIG. 2 is a flow chart illustrating the dynamic resource allocation method according to an exemplary embodiment of the present invention. Referring to both FIG. 1 and FIG. 2, the method proposed in the present embodiment could be implemented by the base station 130 illustrated in FIG. 1, but the invention is not limited thereto. In the following sections, the discussion is made under the assumption that the MTC devices 140 within the communication group G₁ are paged.

In step S210, the base station 130 may estimate a number of contending devices (represented by M₁) in the random access slot. The contending devices may be defined to be the MTC devices 140 within the communication group G₁ that try to perform random access attempt in the current random access slot. Specifically, the number of contending devices (M₁) may be calculated by

$${M}_{i} = {\sum }_{n = 1}^{{N}_{PTmax}} {M}_{i} [ n ] \qquad ( 2 )$$

where Mᵢ[n] is a number of each of the MTC devices 140 transmitting an n-th preamble at the random access slot. In an embodiment of the present invention, Mᵢ[n] may be calculated by

$${M}_{i} [ n ] = {\sum }_{K = {k}_{min}}^{{K}_{max}} {α}_{k , i} {M}_{k , F} [ n - 1 ] . \qquad ( 3 )$$

where Kₘᵢₙ and Kₘₐₓ respectively represent the first and last random access slots from which each of the MTC devices 140 could retransmit in the i-th random access slot. a_{k,i} is the percentage of the MTC devices 140 failing at the k-th random access slot and retransmitting in the i-th random access slot. M_{k,F}[n] is the number of the MTC devices 140 failing their (n−1)-th transmission in the k-th random access slot. By substituting Eq. (3) into Eq. (2), the number of contending devices (Mᵢ) may be correspondingly obtained.

In step S220, the base station 130 may calculate a reference value according to the number of the contending devices (Mᵢ) and a resource allocation parameter (represented by μ). In the present embodiment, the resource allocation parameter (μ) may be the smallest constant chosen to attain the desired QoS requirement. For example, if the QoS requirement is to optimize the access success probability (represented by P_{S}), the base station 130 may obtain the resource allocation parameter (μ) by performing an optimization operation to the access success probability (P_{S}) of a communication group to which the MTC devices 140 belongs (i.e., the communication group G₁). In some embodiments, the access success probability (P_{S}) may be calculated by

$${P}_{S} = \frac{{\sum }_{i = 1}^{{I}_{max}} {\sum }_{n = 1}^{{N}_{PTmax}} {M}_{i , S} [ n ]}{M} \qquad ( 4 )$$

where M_{i,S}[n] is a number of the MTC devices 140 successfully complete a random access procedure at the random access slot after transmitting an n-th preamble. In other embodiments, the resource allocation parameter (μ) may be obtained to satisfy other QoS requirements, such as collision probability or the like, but the invention is not limited thereto.

With the number of the contending devices (Mᵢ) and the resource allocation parameter (μ), the base station 130 may calculate a multiplication value by multiplying the resource allocation parameter and the number of the contending devices. Then, the base station 130 may obtain the reference value by taking a ceiling function to the multiplication value. That is, the reference value may be calculated by ┌μ×Mᵢ┐, where ┌┐ is a ceiling function operator. By substituting Eq. (2) into ┌μ×Mᵢ┐, the reference value may be calculated by

$$⌈ μ \times {\sum }_{n = 1}^{{N}_{PTmax}} {M}_{i} [ n ] ⌉ \qquad ( 5 )$$

In step S230, the base station 130 may calculate a number of specific resources according to the number of the contending devices (Mᵢ), a number of acknowledgeable MTC devices 140 of the base station 130 at the random access slot and a preamble detection probability. The specific resources may be the resources required to detect the number of MTC devices that is less than or equal to N_{UL}. Specifically speaking, the number of the specific resources may be calculated by

$$⌈ - \frac{{\sum }_{n = 1}^{{N}_{PTmax}} {M}_{i} [ n ] {p}_{n}}{ln ( \frac{{N}_{UL}}{{M}_{i}} )} ⌉ \qquad ( 6 )$$

where pₙ is the preamble detection probability of the n-th preamble.

In step S240, the base station 130 may determine a number of reserved random access opportunities according to a maximum number of the random access opportunities (N), the number of the specific resources and the reference value.

Specifically, the base station 130 may take a minimum value among the maximum number of the random access opportunities (N), the reference value (obtained by Eq. (5)) and the number of the specific resources (obtained by Eq. (6)) to be the number of the reserved random access opportunities (Rᵢ). That is, Rᵢ may be characterized as

$${R}_{i} = min ( N , ⌈ μ \times {\sum }_{n = 1}^{{N}_{PTmax}} {M}_{i} [ n ] ⌉ , ⌈ - \frac{{\sum }_{n = 1}^{{N}_{PTmax}} {M}_{i} [ n ] {p}_{n}}{ln ( \frac{{N}_{UL}}{{\sum }_{n = 1}^{{N}_{PTmax}} {M}_{i} [ n ]} )} ⌉ ) . \qquad ( 7 )$$

In step S250, the base station 130 may allocate the resources to the MTC devices 140 within the communication group G₁ according to the number of the reserved random access opportunities (Rᵢ). To be specific, the base station 130 may set the number of the resources used to be allocated to the MTC devices 140 to be equal to Rᵢ. Herein, since the number of the resources used to be allocated to the MTC devices 140 are adequately determined, the base station 130 would not overly allocate unnecessary resources for the contending devices.

Therefore, the resource allocation mechanism performed by the base station 130 could be more efficient by dynamically adjusting the number of the allocated resources (i.e., the reserved random access opportunities) at each of the random access slot. People with ordinary skills in the art should understand that although the MTC devices 140 within the communication group G₁ are taken as examples for illustrating the spirit of the present invention, when another group is paged, the base station 130 may perform the aforementioned dynamic resource allocation method to the MTC devices 140 within the other group as well. Besides, the order of the steps S220 and S230 may be arbitrarily switched according to the requirement of the designer.

In general, since the contending devices may successfully perform a random access attempt or completely fail for reaching the transmission limitation, the number of contending devices would be generally decreasing along with the progressing of the random access slots. Therefore, the number of the reserved random access opportunities at the next random access slot would also be generally decreasing along with the progressing of the random access slots. Accordingly, the increasing unallocated resources may be further used for other purposes, which could further improve the designing degree of freedom of the MTC system 100.

It should be noted that before the base station 130 send the paging message to the MTC devices 140 within the communication group G₁, the base station 130 could pre-calculate the resource allocation parameter (μ). Afterwards, the base station 130 may send the paging message including the resource allocation parameter (μ) to inform the MTC devices 140 within the communication group G₁ to start the random access procedure at the incoming random access slot. The detailed description of the calculation of the resource allocation parameter (μ) could be referred to the related discussion provided in step S220, which would not be repeated herein. Furthermore, the paging message could include some other parameters, such as the maximum number of random access opportunities in a random access slot (N), the number of acknowledgeable MTC devices of the base station at the random access slot (N_{UL}), the total number of the at least one machine-type communication device comprised in the communication group (M) and some other parameters related to the adopted standard of the communication system 100, but the invention is not limited thereto.

After receiving the paging message, the MTC devices 140 within the communication group G₁ could retrieve the resource allocation parameter (u), N and N_{UL} from the paging message and correspondingly find Rᵢ at each random access slot according to the Eq. (7). Therefore, the MTC devices 140 within the communication group G₁ could find Rᵢ with a very low complexity of calculation. Since the design of each of the MTC devices 140 is required to be as simple as possible, the way that the base station 130 inform the MTC devices 140 the resource allocation parameter (μ) along with the paging message could significantly reduce the complexity of the MTC devices 140.

To sum up, the embodiments of the present invention provide a dynamic resource allocation method, which may significantly improve the resource allocation efficiency of the base station. To be specific, the base station may dynamically adjust the number of the reserved random access opportunities at the current random access slot according to the number the contending devices. As a result, the base station would not overly allocate unnecessary resources for the contending devices.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A dynamic resource allocation method, adapted to a base station for allocating resources to at least one machine-type communication device within a communication group at a random access slot, the method comprising:
estimating a number of contending devices in the random access slot;
calculating a reference value according to the number of the contending devices and a resource allocation parameter;
calculating a number of specific resources according to the number of the contending devices, a number of acknowledgeable machine-type communication devices of the base station at the random access slot and a preamble detection probability, wherein the specific resources are the resources required to detect the number of machine-type communication devices that is less than or equal to a number of acknowledgeable machine-type communication devices of the base station at the random access slot;
determining a number of reserved random access opportunities according to a maximum number of the random access opportunities, the number of the specific resources and the reference value; and
allocating the resources to the at least one machine-type communication device according to the number of the reserved random access opportunities.

2. The method as claimed in claim 1, wherein the step of estimating the number of the contending devices in the random access slot comprising:
calculating the number of the contending devices in the random access slot by
$${M}_{i} = {\sum }_{n = 1}^{{N}_{PTmax}} {M}_{i} [ n ]$$
wherein Mᵢ is the number of the contending devices, N_{PTmax} is a number of retransmission limitation of the at least one machine-type communication device and Mᵢ[n] is a number of the at least one machine-type communication device transmitting an n-th preamble at the random access slot.

3. The method as claimed in claim 1, wherein the step of calculating the reference value comprising:
obtaining the resource allocation parameter by performing an optimization operation to an access success probability of the communication group to which the at least one machine-type communication device belongs;
calculating a multiplication value by multiplying the resource allocation parameter and the number of the contending devices; and
obtaining the reference value by taking a ceiling function to the multiplication value.

4. The method as claimed in claim 3, wherein the access success probability is defined as
$${P}_{S} = \frac{{\sum }_{i = 1}^{{I}_{max}} {\sum }_{n = 1}^{{N}_{PTmax}} {M}_{i , S} [ n ]}{M}$$
where P_{S} is the access success probability, Iₘₐₓ is a total number of random access slots in a paging cycle, N_{PTmax} is a number of retransmission limitation of the at least one machine-type communication device, M is a total number of the at least one machine-type communication device comprised in the communication group and M_{i,S}[n] is a number of the at least one machine-type communication device successfully complete a random access procedure at the random access slot after transmitting an n-th preamble.

5. The method as claimed in claim 1, wherein the number of the specific resources is calculated by
$$⌈ - \frac{{\sum }_{n = 1}^{{N}_{PTmax}} {M}_{i} [ n ] {p}_{n}}{ln ( \frac{{N}_{UL}}{{M}_{i}} )} ⌉$$
wherein N_{PTmax} is a number of retransmission limitation of the at least one machine-type communication device, Mᵢ[n] is a number of the at least one machine-type communication device transmitting an n-th preamble at the random access slot, pₙ is the preamble detection probability of the n-th preamble, N_{UL} is the number of acknowledgeable machine-type communication devices of the base station at the random access slot, and ┌┐ is a ceiling function operator.

6. The method as claimed in claim 1, wherein the step of determining the number of the reserved random access opportunities according to the maximum number of the random access opportunities, the number of the specific resources and the reference value comprising:
taking a minimum value among the maximum number of the random access opportunities, the number of the specific resources and the reference value to be the number of the reserved random access opportunities.

7. A dynamic resource allocation method, adapted to a base station for allocating resources to at least one machine-type communication device within a communication group, the method comprising:
obtaining a resource allocation parameter by performing an optimization operation to an access success probability of the communication group to which the at least one machine-type communication device belongs; and
sending a paging message to the at least one machine-type communication device within the communication group, wherein the paging message at least comprises the resource allocation parameter, a number of acknowledgeable machine-type communication device of the base station, a maximum number of random access opportunities in an random access slot and a total number of the at least one machine-type communication device comprised in the communication group.

8. The method as claimed in claim 7, wherein the access success probability is defined as
$${P}_{S} = \frac{{\sum }_{i = 1}^{{I}_{max}} {\sum }_{n = 1}^{{N}_{PTmax}} {M}_{i , S} [ n ]}{M}$$
where P_{S} is the access success probability, Iₘₐₓ is a total number of random access slots in a paging cycle, N_{PTmax} is a number of retransmission limitation of the at least one machine-type communication device, M is a total number of the at least one machine-type communication device comprised in the communication group and M_{i,S}[n] is a number of the at least one machine-type communication device successfully complete a random access procedure at the random access slot after transmitting an n-th preamble.
